(19) United States
(12) Patent Application Publication
(10) Pub. No.: US 2015/0347392 A1
(43) Pub. Date: Dec. 3, 2015

(54) REAL-TIME FILTERING OF MASSIVE TIME SERIES SETS FOR SOCIAL MEDIA TRENDS

(71) Applicant: INTERNATIONAL BUSINESS MACHINES CORPORATION, Armonk, NY (US)

(72) Inventors: Paulo Rodrigo Cavalin, Sao Paulo (BR); Maira Athanazio De Cerqueira Gatti, Sao Paulo (BR); Daniel Lemes Gribel, Sao Paulo (BR); Rogerio Abreu De Paula, Sao Paulo (BR); Claudio Santos Pinhanez, Sao Paulo (BR); Alexandre Rademaker, Sao Paulo (BR)

(73) Assignee: INTERNATIONAL BUSINESS MACHINES CORPORATION, Armonk, NY (US)

(21) Appl. No.: 14/290,778

(22) Filed: May 29, 2014

(51) Int. Cl. G06F 17/27

(52) U.S. Cl. CPC G06F 17/2775

(57) ABSTRACT

A method for determining significant words or phrases within social media data includes receiving a stream of data from at least one social media source. The stream includes one or more words or phrases along with corresponding time stamps indicating when the word/phrase was used. One or more words/phrases to be analyzed is determined from the stream. A time period of interest is identified. The time period is divided into a plurality of non-overlapping time windows. The stream is analyzed within the time period of interest to determine how many instances of each words/phrases have timestamps within each time window. One or more of the words/phrases are identified as significant based on a level of co-occurrence of the words/phrases related to the determination as to how many instances of each words/phrases have timestamps within each window.

### TECHNICAL FIELD

The present disclosure relates to social media trends and, more specifically, to a system and method for real-time filtering of massive time series sets for trends in social media.

### DISCUSSION OF THE RELATED ART

Social media, broadly defined, is the interaction among people in which they create, share, and/or exchange information and ideas with each other via a connected electronic network. It is distinguishable from traditional media in so far as traditional media only facilitates the dissemination of information from source to the public, with only very limited opportunities for the public to communicate back to the source or to communicate with other members of the public. Social medial is distinguishable from traditional social interaction, in part, because social media provides the individual the ability to quickly and easily interact with large groups of people and even the general public. Social media most often utilizes the Internet as a means of connection, however, this is not a requirement. Social media may occur over other electronic networks such as various telecommunications networks and networks of connected devices, for example, the so-called Internet of Things, without regard to the infrastructure used to enable the communication.

Many have observed that there is considerable value in mining the considerable data that travels through social media, and as this data is often openly available, for example, over the Internet, a primary task for deriving value from social media data resides in being able to process the extremely large volumes of data as it becomes available. The quantity of data involved in social media interactions, often characterized simply as “big data” can include millions of distinct communications each and every minute, achieving petabytes or terabytes of data. The sheer size of this readily available social media data presents a challenge for effective and meaningful visualization thereof.

### SUMMARY

A method for determining significant words or phrases within social media data includes receiving a stream of data from at least one social media source over a computer network. The stream of data includes the use of one or more words or phrases (words/phrases) along with corresponding time stamps indicating when the word/phrase was used or received. One or more words/phrases to be analyzed is determined from the stream of data. A time period of interest is identified. The time period includes a start time before which words/phrases having an earlier timestamp are not used and an end time after which words/phrases having a later timestamp are not used. The time period is divided into a plurality of non-overlapping time windows. The stream of data is analyzed within the time period of interest to determine how many instances of each words/phrases have timestamps within each time window. One or more of the words/phrases are identified as significant based on the determination as to how many instances of each words/phrases have timestamps within each window.

Identifying one or more of the words/phrases as significant may include constructing an M×N occurrence matrix for the words/phrases and their timestamps. Here M is a positive integer representing the number of detected words/phrases and N is a positive integer representing the number of timestamps in the time period of interest.

Identifying one or more of the words/phrases as significant may further include normalizing the constructed occurrence matrix such that each number of detected words/phrases at each timestamp is a number between 0 and 1.

Identifying one or more of the words/phrases as significant may further include reducing the normalized occurrence matrix to remove entries having little or no correlation within the normalized matrix to other words/phrases therein.

Identifying one or more of the words/phrases as significant may further include calculating a co-relation matrix from the normalized occurrence matrix as the normalized occurrence matrix multiplied by its own transpose. Diagonal values of the co-relation matrix may be replaced with zeroes to discard repetitive information. All but a set of entries with a highest co-occurrence may be removed from the co-relation matrix with discarded repetitive information to produce a Maximum Correlation Rate (MCR) list.

Removing all but a set of entries with a highest co-occurrence may include keeping a top k entries, where k is a predetermined positive integer.

Removing all but a set of entries with a highest co-occurrence may include keeping a set of entries prior to a drop-off on a plotted curve of the MCR entries and their respective level of co-occurrence.

Removing all but the set of entries with the highest co-occurrence may result in a reduced matrix of words/phrases identified as significant.

Sentiment analysis may be performed on the words/phrases of the stream of data to divide identical words/phrases according to context sentiment and treating words/phrases so-divided as distinct words/phrases for the purposes of analyzing the stream of data within the time period of interest to determine how many instances of each words/phrases have timestamps within each time window.

A method for displaying social media data includes receiving a stream of data from at least one social media source over a computer network, the stream of data including the use of one or more words or phrases (words/phrases) along with corresponding time stamps indicating when the word/phrase was used or received. One or more words/phrases are determined to be analyzed from the stream of data. A time period of interest is identified, the time period including a start time before which words/phrases having an earlier timestamp are not used and an end time after which words/phrases having a later timestamp are not used. Time period is divided into a plurality of non-overlapping time windows. The stream of data within the time period of interest is analyzed to determine how many instances of each words/phrases have timestamps within each time window. A degree of co-occurrence among each of the words/phrases to be analyzed is determined using the analysis of how many instances of each words/phrases have timestamps within each time window. One or more of the words/phrases is identified as significant based on the determination of the degree of co-occurrence. The identified one or more words/phrases of significance are displayed.

Determining a degree of co-occurrence may include assessing a level by which each word/phrase of the determined words/phrases exhibits a pattern close to the other words/phrases of the determined words/phrases with respect to how many instances of each words/phrases have timestamps within each window.

Identifying one or more of the words/phrases as significant may include constructing an M×N occurrence matrix for the words/phrases and their timestamps. Here, M is a positive integer representing the number of detected words/phrases and N is a positive integer representing the number of timestamps in the time period of interest.

Identifying one or more of the words/phrases as significant may further include normalizing the constructed occurrence matrix such that each number of detected words/phrases at each timestamp is a number between 0 and 1.

Identifying one or more of the words/phrases as significant may further include reducing the normalized occurrence matrix to remove entries having little or no correlation within the normalized matrix to other words/phrases therein.

Identifying one or more of the words/phrases as significant may further include calculating a co-relation matrix from the normalized occurrence matrix as the normalized occurrence matrix multiplied by its own transpose. Diagonal values of the co-relation matrix may be replaced with zeroes to discard repetitive information. All but a set of entries with a highest co-occurrence may be removed from the co-relation matrix with discarded repetitive information to produce a Maximum Correlation Rate (MCR) list.

Removing all but a set of entries with a highest co-occurrence may include keeping a top k entries, where k is a predetermined positive integer.

Removing all but a set of entries with a highest co-occurrence may include keeping a set of entries prior to a drop-off on a plotted curve of the MCR entries and their respective level of co-occurrence.

Removing all but the set of entries with the highest co-occurrence may results in a reduced matrix of words/phrases identified as significant.

Sentiment analysis may be performed on the words/phrases of the stream of data to divide identical words/phrases according to context sentiment and treating words/phrases so-divided as distinct words/phrases for the purposes of analyzing the stream of data within the time period of interest to determine how many instances of each words/phrases have timestamps within each time window.

A computer system includes a processor and a non-transitory, tangible, program storage medium, readable by the computer system, embodying a program of instructions executable by the processor to perform method steps for determining significant words or phrases within social media data. The method includes receiving a stream of data from at least one social media source over a computer network, the stream of data including the use of one or more words or phrases (words/phrases) along with corresponding time stamps indicating when the word/phrase was used or received. One or more words/phrases to be analyzed are determined from the stream of data. A time period of interest is identified, the time period including a start time before which words/phrases having an earlier timestamp are not used and an end time after which words/phrases having a later timestamp are not used. The time period is divided into a plurality of non-overlapping time windows. The stream of data is analyzed within the time period of interest to determine how many instances of each words/phrases have timestamps within each time window. A degree of co-occurrence among each of the words/phrases to be analyzed is determined using the analysis of how many instances of each words/phrases have timestamps within each time window. One or more of the words/phrases are identified as significant based on the determination of the degree of co-occurrence.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a flow chart illustrating an approach for performing analysis of social media data in accordance with exemplary embodiments of the present invention;

FIG. 2 is a plotted curve of ordered MCR values for an exemplary data set;

FIG. 3 is a schematic diagram illustrating an example apparatus for performing analysis of social media data in accordance with exemplary embodiments of the present invention;

FIG. 4 is an example of a graphical display of data from a filtered matrix in accordance with exemplary embodiments of the present invention;

FIG. 5 is an example of an alternative graphical display of data from a filtered matrix in accordance with exemplary embodiments of the present invention; and

FIG. 6 shows an example of a computer system capable of implementing the method and apparatus according to embodiments of the present disclosure.

### DETAILED DESCRIPTION OF THE DRAWINGS

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention provide methods and systems for the collection, processing and presentment of social media data in real-time. As the quantity of available social media data may be extremely large, exemplary embodiments of the present invention seek to provide effective approaches for automatically filtering the available data so that highly relevant data may be visualized without the need for human selection and/or curation. Social media data curation may focus on tracking the frequency with which various key words and/or phrases are used so that a set of most commonly used words/phrases may be presented. In addition to analyzing key words/phrases, exemplary embodiments of the present invention may examine topics, which may be defined herein as a set of words/phrases that are known to relate to the same concept. Accordingly, for the purposes of this disclosure, the tracking of a word or phrase may include the tracking of other words/phrases related to a common topic as if they were the same word/phrase.

Social media data curation may also focus on sets of words/phrases/topics that, while perhaps not presently the most commonly occurring words/phrases/topics found within the dataset, may exhibit a fast pace of acceleration in the measure of how common the words/phrases/topics are present in the dataset. These styles of curation may be referred to as “popular” and “trending” respectively.

However, as many popular and/or trending words/phrases/topics have only trivial value (for example, the occurrence of the word “the”), social media data curation generally involves a large amount of curation on the part of a set of human users and/or a crowdsourcing approach whereby the public is called upon to help assess the relevance of individual terms/phrases/topics.

Exemplary embodiments of the present invention may provide a fully automated approach that requires neither expert curation nor crowdsourcing to reduce the social media data stream. Exemplary embodiments of the present invention may achieve this curation by a process of filtering the received data-stream in real-time by factors including correlation of patterns of occurrence over time between various words, phrases, and/or/topics under the notion that important words/phrases/topics tend to correlate by time of presentment with other important words/phrases/topics. This concept is unrelated to correlation by proximity, where a word/phrase/topic is believed to be important when it is often used together with another important word/phrase/topic (e.g. in the same sentence). Moreover, exemplary embodiments of the present invention may also or alternatively seek to determine whether a use of a word/phrase/topic, over time, appears to be not as expected and therefore anomalous, as word/phrase/topic showing anomalous usage over time may also be considered important/relevant.

To illustrate this distinction by example, correlation of patterns of occurrence over time may consider word B to be important if it appears to be used often while word A is also being used often and appears to be used less frequently while word A is used less frequently, even if words A and B do not necessarily appear together (e.g. as part of the same sentence) in the data. Correlation by pattern of occurrence may therefore be unconcerned with whether two words are used as part of the same sentence or otherwise appear close to each other within a single thread of data, and may instead be concerned with whether two words share a similar pattern of use over time or a given word presents an anomalous pattern of use.

Thus consider a case in which a sporting event is underway, references may be made to a goal being scored. However, at different points in the sporting event, discussion of a goal scored may relate to a different goal being scored and traditional approaches for analyzing social media data that focus only on frequency of usage and trending usage may not be able to identify the goals as unique events. Additionally, if an athlete has multiple different names that are used by different people, traditional approaches may not be able to easily associate the occurrence of all the different names as part of the same entity.

However, exemplary embodiments of the present invention, by employing a filtering based, at least in part on correlation of patterns of occurrence over time may recognize a temporal correlation between the word “goal” and a particular player's name and recognize a unique event and at the same time may recognize a temporal correlation between two different versions of the same name and recognize that the two names are related.

For example, TABLE 1 below shows an example of a pattern of use within a time window for time t=1 to 3 for the words “goal,” “Alice,” “Abby,” “Brenda,” and “Hornet.”

TABLE 1

| | t = 1 | t = 2 | t = 3 |
|---|---|---|---|
| Goal | 109 | 20 | 120 |
| Alice | 115 | 12 | 23 |
| Abby | 30 | 21 | 138 |
| Brenda | 23 | 25 | 24 |
| Hornet | 5 | 4 | 23 |

Exemplary embodiments of the present invention, when employing filtering by patterns of occurrence over time may be able to understand that the use of the word “goal” at time t=1 is associated with a distinct event from the use of that same word at time t=3 and understand that the word “Hornet” is important and associated with what may be a singular event of “Abby” scoring a “Goal” at time t=3, even though the frequency of occurrence of “Hornet” is less than that of “Brenda.”

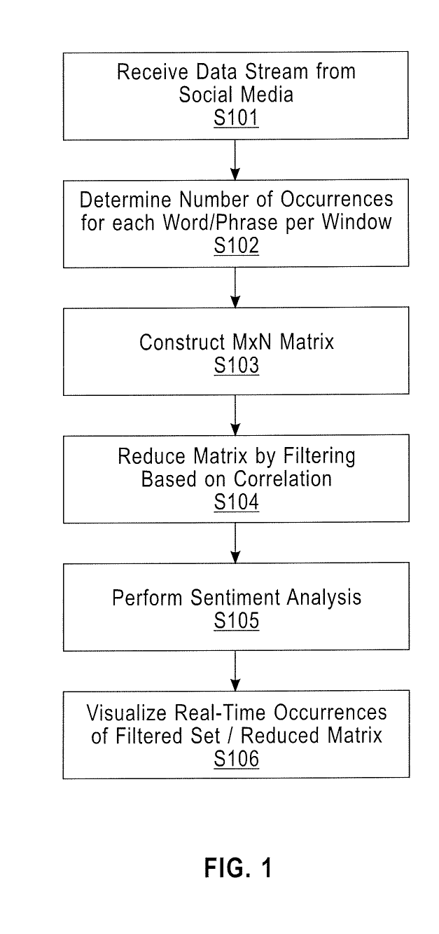

A more detailed discussion of the above will be provided below with reference to the figures. FIG. 1 is a flow chart illustrating an approach for performing analysis of social media data in accordance with exemplary embodiments of the present invention.

First, social media data may be received (Step S101). The social media data may be data derived from one or more social media sources. Each social media source may be an internet-based social network or may be, more generally, communication content generated as part of a social interaction between human or machine users, associated as peers, through an electronic communication network. The social media data may, for example, be obtained from one or more internet-based social networks and may include a real-time stream of messages that are sent between individuals or from an individual to a group. The social media data may be either structured or unstructured.

As an optional step, topic classification and/or sentiment analysis may be performed on the received social media data (Step S102). Topic classification may be understood herein to be the approach by which various words/phrases are grouped together into topics so that differing words/phrases within a particular set called a topic may be treated as the same word/phrase. Sentiment analysis may be used to determine a context of the use of each word/phrase/topic. In the simplest example, context may be characterized as either positive or negative, indicating whether the word/phrase/topic has been used in a positive or negative context. However, sentiment analysis may be performed with greater granularity. For example, multiple levels of positive and negative sentiment may be defined to characterize a degree to which the sentiment is expressed in its context. Sentiment may also be characterized as neutral. Sentiment may also be divided into categories, with the context of the word/phrase/topic being characterized. For example, sentiment analysis may be performed to determine whether a use of a word/phrase represents approval, sympathy, surprise, anxiety, fear, disapproval, confusion, etc. Moreover, sentiment analysis may be performed to provide a quantified value for one or more context categories. Topic classification and sentiment analysis may each be considered herein to be “text analytics” and accordingly, the performance of either sentiment analysis or topic classification may be herein referred to as text analytics.

As mentioned above, use of text analytics is an optional step and may be omitted. However, where sentiment analysis is used, the outcome of the analysis may be used to treat examples of the invocation of a word/phrase/topic within the social media data stream as if it were a different word/phrase/topic depending on the sentiment measure attributed to it. For example, the use of the word “goal” in a positive context may be treated as a distinct word than use of the word “goal” in a negative context. Accordingly, the determination as to whether a word/phrase/topic correlates with another word/phrase/topic may be performed with respect to the context of the word/phrase/topic. For example, exemplary embodiments of the present invention may be concerned with whether the use of a word/phrase/topic in a particular context is correlated with the use of a trending and/or popular word/phrase/topic.

The social media data stream may then be analyzed to quantify an occurrence of words, phrases, and/or topics therein (Step S103). This step may include keeping a tally of the number of times each appearing word appears within the data and where phrases are considered, this step may include identifying phrases from the data and keeping a tally of the number of times each identified phrase appears within the data. For the purposes of this step, a plurality of time windows may be defined and the social media data stream may be divided by the established time windows. The tally may be a direct count of the number of times each word/phrase is identified within the social media data falling within the present time window and each occurrence may also be noted along with a timestamp, which indicates when, within the time window, the word/phrase was used. Where text analytics has been performed (Step S102), the occurrence of a word/phrase/topic may be separately quantified for each sentiment category.

This information may then be used to construct an occurrence matrix for the words/phrases/topics (Step S104). The occurrence matrix may be an M×N matrix, where M and N are positive integers. The occurrence matrix may have rows representing words/phrases/topic and columns representing timestamps. In this way, TABLE 1 above may be seen as a simplified example of an occurrence matrix in accordance with exemplary embodiments of the present invention. Thus M may be the number of detected words/phrases/topic and N may be the number of possible or observed timestamps. The detected words/phrases/topic may be numbered as i=1 M and the timestamps may be numbered as j=1 . . . M. Thus each entry in the occurrence matrix may have coordinates (i,j). As the data is expected to be very large, and it is unlikely that all words/phrases/topic will be observed at all timestamps, the occurrence matrix may have many empty entries.

Where text analytics has been performed (Step S102), uses of a word/phrase/topic with a particular sentiment characterization may either be treated as distinct entries in the matrix or alternatively, there may be different matrices established for each sentiment category. For example, there may be one matrix representing the frequency for which words are used in a positive context with respect to time buckets and another matrix representing the frequency for which the same words are used in a negative context with respect to the time buckets.

The initial occurrence matrix, for example, as seen in TABLE 1 may be referred to herein as Matrix A, however, to facilitate comparison, the matrix may be normalized. The normalized matrix may be referred to herein as Matrix A′. As the matrix is constructed per-window, a first normalized matrix A′ may represent a time interval[0,1], a second normalized matrix A′ may represent a time interval[1,2], etc.

TABLE 2, provided below, is an example of a normalized matrix A′ for the matrix A of TABLE 1.

TABLE 2

| | t = 1 | t = 2 | t = 3 |
|---|---|---|---|
| Goal | 0.78985507 | 0.14492754 | 0.86956522 |
| Alice | 0.83333333 | 0.08695652 | 0.16666667 |
| Abby | 0.2173913 | 0.15217391 | 1 |
| Brenda | 0.16666667 | 0.18115942 | 0.17391304 |

The matrix may be reduced by filtering out data based on lack of correlation of patterns of occurrence (Step S105), as discussed in detail above. In practice, this filtering may be achieved by performing the following analysis:

The transpose of Matrix A′ may be used to compute a co-relation matrix that may be calculated as: C=A′×A′^{T}, where the co-relation matrix C represents the overlap of words/phrases in timestamps. Thus C is a square symmetric matrix of size M×M with rows and columns corresponding to each of the terms obtained in A′.

TABLE 3 below illustrates the transpose of the matrix A′ (A′^{T}).

TABLE 3

| | Goal | Alice | Abby | Brenda | Hornet |
|---|---|---|---|---|---|
| t = 1 | 0.789855072 | 0.833333333 | 0.217391304 | 0.166666667 | 0.036231884 |
| t = 2 | 0.144927536 | 0.086956522 | 0.152173913 | 0.18115942 | 0.028985507 |
| t = 3 | 0.869565217 | 0.166666667 | 1 | 0.173913043 | 0.166666667 |

Here the occurrence matrix A is a snapshot incidence matrix, the entry (i,j) in matrix C is a measure of the overlap between the i-th and j-th terms, based on their co-occurrence in snapshots. So the entry (i,j) in C generates a value that essentially measures how many timestamps both term i and term j occur.

TABLE 4 below illustrates the C matrix, as calculated using the transpose matrix.

TABLE 4

| | Goal | Alice | Abby | Brenda | Hornet |
|---|---|---|---|---|---|
| Goal | 1.401018694 | 0.815742491 | 1.063327032 | 0.309126234 | 0.177746272 |
| Alice | 0.815742491 | 0.729783659 | 0.361058601 | 0.183627389 | 0.060491493 |
| Abby | 1.063327032 | 0.361058601 | 1.070415879 | 0.237712665 | 0.178954001 |
| Brenda | 0.309126234 | 0.183627389 | 0.237712665 | 0.09084226 | 0.040275152 |
| Hornet | 0.177746272 | 0.060491493 | 0.178954001 | 0.040275152 | 0.029930687 |

The diagonal values of the C matrix may be replaced by zero since they represent the co-occurrence of the same word/phrase/topic in the same snapshot and can be discarded. TABLE 5 below illustrates the normalized matrix having self-correlations set to zero.

TABLE 5

| | Goal | Alice | Abby | Brenda | Hornet |
|---|---|---|---|---|---|
| Goal | 0 | 0.815742491 | 1.063327032 | 0.309126234 | 0.177746272 |
| Alice | 0.815742491 | 0 | 0.361058601 | 0.183627389 | 0.060491493 |
| Abby | 1.063327032 | 0.361058601 | 0 | 0.237712665 | 0.178954001 |
| Brenda | 0.309126234 | 0.183627389 | 0.237712665 | 0 | 0.040275152 |
| Hornet | 0.177746272 | 0.060491493 | 0.178954001 | 0.040275152 | 0 |

Filtering on correlation of pattern occurrence therefore may be seen as an identification of a set of words/phrases/topics (a set “k”) with a highest co-occurrence. To compute the k highest co-occurrences in C, matrix C values may be sorted by considering only the Maximum Correlation Rate (MCR) of the words/phrases/topics, since one word/phrase/topic can be correlated with more than one other word/phrase/topic. The final terms may be collected therefrom it in a ranking vector L, preserving all timestamps. Here, k may be the chosen rank based on L values. This approach for ranking co-occurrence is offered merely as an example and other approaches may be used to identify k.

TABLE 6 below illustrates the computed MCR according to the example provided.

TABLE 6

| | |
|---|---|
| Goal | 1.063327032 |
| Alice | 0.815742491 |
| Abby | 1.063327032 |
| Brenda | 0.309126234 |
| Hornet | 0.178954001 |
| Goal | 1.063327032 |

TABLE 7 below illustrates the sorted MCR list in which the terms are ranked in order so that the k top results may be easily gleamed.

TABLE 7

| | | k |
|---|---|---|
| Goal | 1.063327032 | 1 |
| Abby | 0.815742491 | 2 |
| Alice | 0.815742491 | 3 |
| Brenda | 0.309126234 | 4 |
| Hornet | 0.178954001 | 5 |

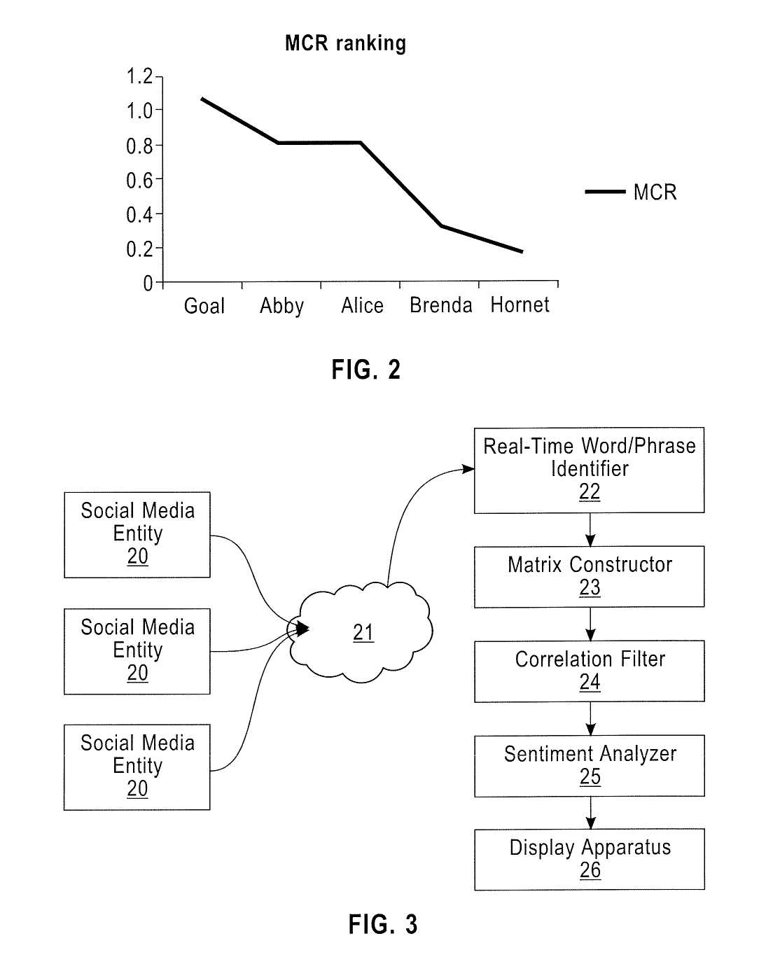

While there may be many approaches for determining the value to use for k, which may be analogous to determining which results are to be considered the top result, in the interests of providing a simplified example, a plot of the series including normalized MCRs may be analyzed to determine where the data most clearly defines a set of top results. FIG. 2 is a plotted curve of the ordered MCR values for the exemplary data set. As can be seen from this curve, there is quite a steep drop-off after the third word. Accordingly, k may be set to 3.

After the set of most highly co-related words/phrases/topics k has been identified, the matrix A may be filtered by keeping all timestamps and the remaining terms obtained by the k rank reduction. The other terms may be dropped. This generates a reduced matrix Aₖ which may be relatively small as compared to the original data set and may therefore be more appropriately used for visualization purposes.

TABLE 8 below illustrates the reduced matrix showing the top three words (k=3) according to the exemplary data.

TABLE 8

| | |
|---|---|
| Goal | 1.06 |
| Abby | 0.82 |
| Alice | 0.82 |

However, co-relation, as described above, need not be the only criteria for prioritizing word/phrase entries of the matrix, co-relation may be combined with other known approaches for prioritization such as popularity, or trendiness and may even be combined with expert curation or crowdsourced selection.

As will be discussed in detail below, the filtered set of key words/phrases/topics may be visualized, for example, together with its timestamp data, in a graphical display (Step S106). Sentiment analysis may also be incorporated into the visualization, for example, different visualizations may be provided for different sentiment characterizations or sentiment analysis results may be displayed alongside the word/phrases/topics in the visualization.

FIG. 3 is a schematic diagram illustrating an example apparatus for performing analysis of social media data in accordance with exemplary embodiments of the present invention. Each module described herein may be embodied as including one or more computer systems executing programs for performing the described functions. Moreover, multiple illustrated modules may be combined in a single computer system. A real-time word/phrase/topic identifier 32 may be configured to obtain social media data over a computer network 31 such as the Internet. The social media data may be collected from a plurality of different social media entities 30, each of which may be, for example, a social network. The real-time word/phrase/topic identifier may be configured to identify one or more words, phrases, or topics from the received data, for example, by matching against a dictionary and/or phrase list. A matrix constructor 33 may be configured to create the full matrix including all words/phrases identified by the word/phrase identifier 32, along with associated time stamp data. The matrix constructor 33 may also be configured to normalize the matrix and determine its transpose, for example, as described above.

A correlation filter may be configured to reduce the matrix created from the matrix constructor 33 down to a set of entries exhibiting a highest co-occurrence, for example, as described in detail above.

A combiner 35 may be configured to merge the result of the filtering in accordance with the results of textual analytics, and in particular, with the sentiment dimension. Sentiment may either be determined as positive/negative/neutral or assigned a level of sentiment.

A display apparatus 36 may be configured to produce an illustrative graph of the results of either the correlation filter 34 or the combiner 35, for example, by creating a frequency line graph or a frequency color graph, as described in detail below. The generated graph may be displayed, for example, on a display screen and/or may be made available over the Internet.

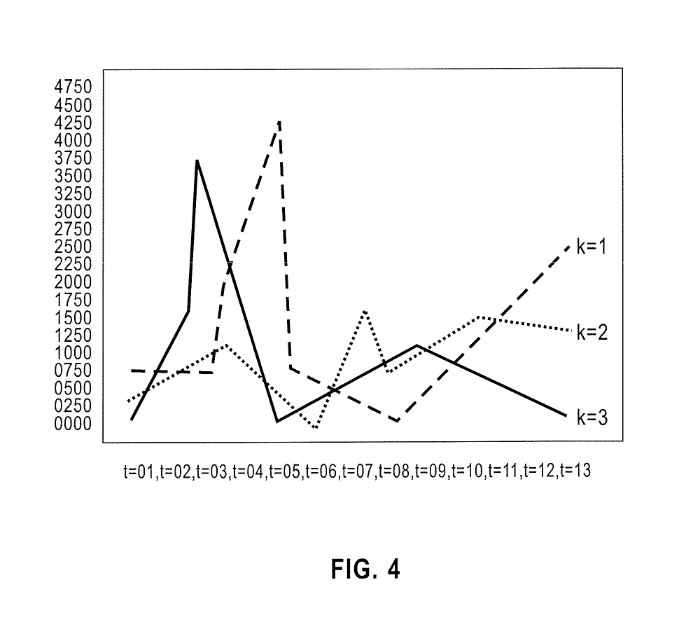

As mentioned above, the filtered set of k words/phrases may be visualized together with its timestamp data, in a graphical display (Step S106). FIG. 4 is an example of a graphical display of data from a filtered matrix in accordance with exemplary embodiments of the present invention. For the purpose of providing a simple example, the top three co-occurrence results (k=1, k=2, and k=3) are plotted. The x-axis features time stamps, simplified as t=1 through t=13, while the y-axis features frequency of mentions for the word/phrase at the given time stamp. The range of frequencies shown is 0 though 4750. The entire visualization is provided for a set time window, as described above. However, as data may continue to be collected and analyzed, the graphical display may scroll from right to left as new data appears in the right and old data disappears to the left. As different words/phrases may be of greater relevance at different times, some curves may end at a given time stamp while other curves may begin at a given time stamp. This type of graphical representation may be referred to herein as a frequency line graph.

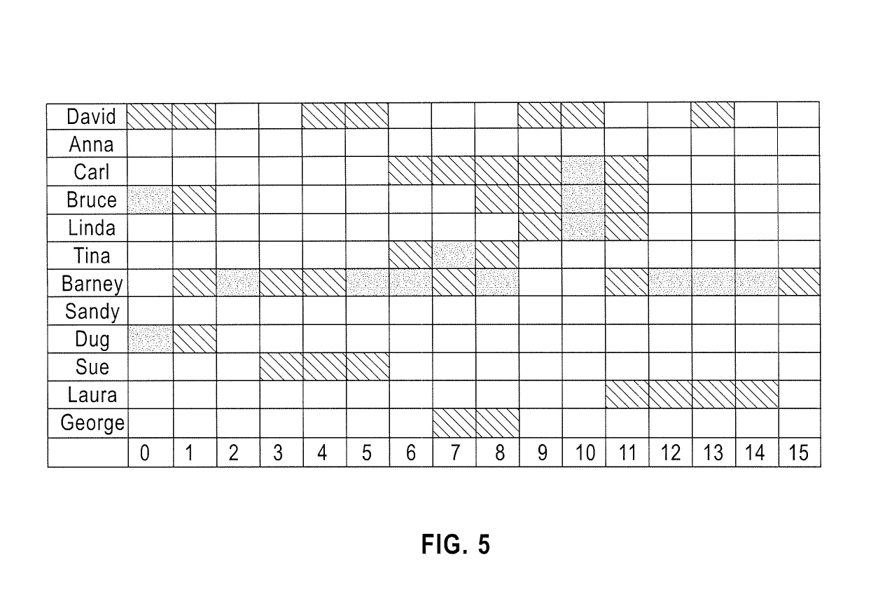

FIG. 5 is an example of an alternative graphical display of data from a filtered matrix in accordance with exemplary embodiments of the present invention. Here there are k=12 highest co-occurrence results shown for t= to 15 different time stamps with frequency shown in terms of color, with black boxes being most frequently occurring, white boxes being least frequently occurring, and gray boxes representing moderate occurrence. While only three shades have been shown for the purpose of providing a simplified example, there may be many different shades used and different colors may be used as well so that the graph may illustrate frequency with any desired level of granularity. This type of graphical representation may be referred to herein as a frequency color graph.

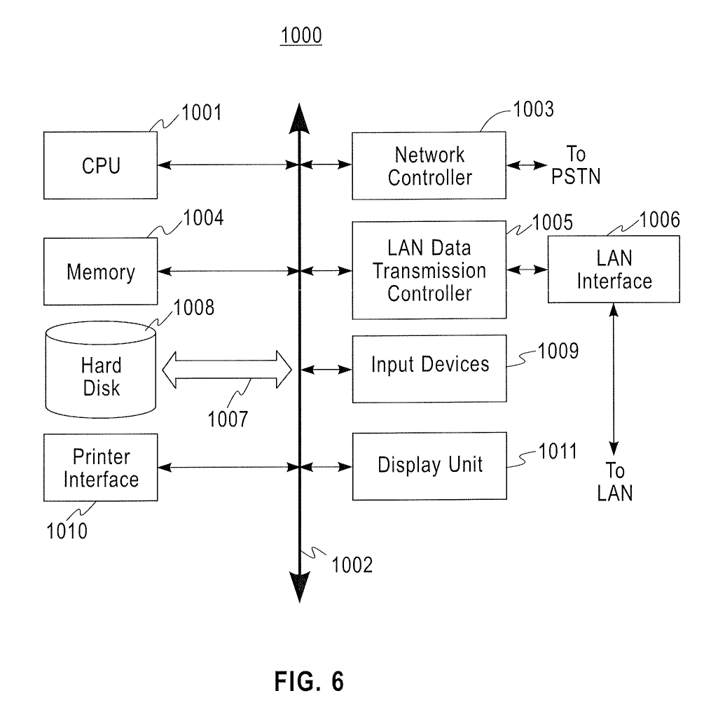

FIG. 6 shows an example of a computer system which may implement a method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A method for determining significant words or phrases within social media data, comprising:
receiving a stream of data from at least one social media source over a computer network, the stream of data including the use of one or more words or phrases (words/phrases) along with corresponding time stamps indicating when the word/phrase was used or received;
determining one or more words/phrases to be analyzed from the stream of data;
identifying a time period of interest, the time period including a start time before which words/phrases having an earlier timestamp are not used and an end time after which words/phrases having a later timestamp are not used;
dividing the time period into a plurality of non-overlapping time windows;
analyzing the stream of data within the time period of interest to determine how many instances of each words/phrases have timestamps within each time window; and
identifying one or more of the words/phrases as significant based on the determination as to how many instances of each words/phrases have timestamps within each window.

2. The method of claim 1, wherein identifying one or more of the words/phrases as significant includes constructing an M×N occurrence matrix for the words/phrases and their timestamps, wherein M is a positive integer representing the number of detected words/phrases and N is a positive integer representing the number of timestamps in the time period of interest.

3. The method of claim 2, wherein identifying one or more of the words/phrases as significant further includes normalizing the constructed occurrence matrix such that each number of detected words/phrases at each timestamp is a number between 0 and 1.

4. The method of claim 3, wherein identifying one or more of the words/phrases as significant further includes reducing the normalized occurrence matrix to remove entries having little or no correlation within the normalized matrix to other words/phrases therein.

5. The method of claim 3, wherein identifying one or more of the words/phrases as significant further includes:
calculating a co-relation matrix from the normalized occurrence matrix as the normalized occurrence matrix multiplied by its own transpose;
replacing diagonal values of the co-relation matrix with zeroes to discard repetitive information; and
removing all but a set of entries with a highest co-occurrence from the co-relation matrix with discarded repetitive information to produce a Maximum Correlation Rate (MCR) list.

6. The method of claim 5, wherein removing all but a set of entries with a highest co-occurrence includes keeping a top k entries, where k is a predetermined positive integer.

7. The method of claim 5, wherein removing all but a set of entries with a highest co-occurrence includes keeping a set of entries prior to a drop-off on a plotted curve of the MCR entries and their respective level of co-occurrence.

8. The method of claim 5, wherein removing all but the set of entries with the highest co-occurrence results in a reduced matrix of words/phrases identified as significant.

9. The method of claim 1, wherein sentiment analysis is be performed on the words/phrases of the stream of data to divide identical words/phrases according to context sentiment and treating words/phrases so-divided as distinct words/phrases for the purposes of analyzing the stream of data within the time period of interest to determine how many instances of each words/phrases have timestamps within each time window.

10. A method for displaying social media data, comprising:
receiving a stream of data from at least one social media source over a computer network, the stream of data including the use of one or more words or phrases (words/phrases) along with corresponding time stamps indicating when the word/phrase was used or received;
determining one or more words/phrases to be analyzed from the stream of data;
identifying a time period of interest, the time period including a start time before which words/phrases having an earlier timestamp are not used and an end time after which words/phrases having a later timestamp are not used;
dividing the time period into a plurality of non-overlapping time windows;
analyzing the stream of data within the time period of interest to determine how many instances of each words/phrases have timestamps within each time window;
determining a degree of co-occurrence among each of the words/phrases to be analyzed using the analysis of how many instances of each words/phrases have timestamps within each time window;
identifying one or more of the words/phrases as significant based on the determination of the degree of co-occurrence; and
displaying the identified one or more words/phrases of significance.

11. The method of claim 10, wherein determining a degree of co-occurrence includes assessing a level by which each word/phrase of the determined words/phrases exhibits a pattern close to the other words/phrases of the determined words/phrases with respect to how many instances of each words/phrases have timestamps within each window.

12. The method of claim 10, wherein identifying one or more of the words/phrases as significant includes constructing an M×N occurrence matrix for the words/phrases and their timestamps, wherein M is a positive integer representing the number of detected words/phrases and N is a positive integer representing the number of timestamps in the time period of interest.

13. The method of claim 12, wherein identifying one or more of the words/phrases as significant further includes normalizing the constructed occurrence matrix such that each number of detected words/phrases at each timestamp is a number between 0 and 1.

14. The method of claim 13, wherein identifying one or more of the words/phrases as significant further includes reducing the normalized occurrence matrix to remove entries having little or no correlation within the normalized matrix to other words/phrases therein.

15. The method of claim 13, wherein identifying one or more of the words/phrases as significant further includes:
calculating a co-relation matrix from the normalized occurrence matrix as the normalized occurrence matrix multiplied by its own transpose;
replacing diagonal values of the co-relation matrix with zeroes to discard repetitive information; and
removing all but a set of entries with a highest co-occurrence from the co-relation matrix with discarded repetitive information to produce a Maximum Correlation Rate (MCR) list.

16. The method of claim 15, wherein removing all but a set of entries with a highest co-occurrence includes keeping a top k entries, where k is a predetermined positive integer.

17. The method of claim 15, wherein removing all but a set of entries with a highest co-occurrence includes keeping a set of entries prior to a drop-off on a plotted curve of the MCR entries and their respective level of co-occurrence.

18. The method of claim 15, wherein removing all but the set of entries with the highest co-occurrence results in a reduced matrix of words/phrases identified as significant.

19. The method of claim 11, wherein sentiment analysis is be performed on the words/phrases of the stream of data to divide identical words/phrases according to context sentiment and treating words/phrases so-divided as distinct words/phrases for the purposes of analyzing the stream of data within the time period of interest to determine how many instances of each words/phrases have timestamps within each time window.

20. A computer system comprising:
a processor; and
a non-transitory, tangible, program storage medium, readable by the computer system, embodying a program of instructions executable by the processor to perform method steps for determining significant words or phrases within social media data, the method comprising:
receiving a stream of data from at least one social media source over a computer network, the stream of data including the use of one or more words or phrases (words/phrases) along with corresponding time stamps indicating when the word/phrase was used or received;
determining one or more words/phrases to be analyzed from the stream of data;
identifying a time period of interest, the time period including a start time before which words/phrases having an earlier timestamp are not used and an end time after which words/phrases having a later timestamp are not used;
dividing the time period into a plurality of non-overlapping time windows;
analyzing the stream of data within the time period of interest to determine how many instances of each words/phrases have timestamps within each time window;
determining a degree of co-occurrence among each of the words/phrases to be analyzed using the analysis of how many instances of each words/phrases have timestamps within each time window; and
identifying one or more of the words/phrases as significant based on the determination of the degree of co-occurrence.
